(19) United States
(12) Patent Application Publication
(10) Pub. No.: US 2008/0244469 A1
(43) Pub. Date: Oct. 2, 2008

(54) METHOD OF OPTIMIZING THE DISPLAYING OF IMAGE MEDIA ON A WIRELESS COMMUNICATIONS DEVICE

(75) Inventors: Andrew James TURCOTTE, Stittsville (CA); Samer FAHMY, Waterloo (CA)

Correspondence Address: OGILVY RENAULT LLP, 1981 MCGILL COLLEGE AVENUE, SUITE 1600, MONTREAL, QC, H3A2Y3, CA

(73) Assignee: RESEARCH IN MOTION LIMITED, Waterloo (CA)

(21) Appl. No.: 11/693,832

(22) Filed: Mar. 30, 2007

(51) Int. Cl. G06F 3/14

(52) U.S. Cl. 715/864

(57) ABSTRACT

A method of displaying image media on a display of a wireless communications device entails displaying a hybrid view of the image media by presenting a list of folders containing image media and by concurrently presenting thumbnail images of the image media corresponding to at least one of the folders. The thumbnail images can be scaled-down images of digital pictures or scaled-down frames of digital video. Optionally, when the user selects one of the thumbnail images, the display presents the file name and file size.

### CROSS-REFERENCE TO RELATED APPLICATIONS

This is the first application filed for the present invention.

### TECHNICAL FIELD

The present disclosure relates generally to techniques for displaying image media and, in particular, to techniques for displaying image media on wireless communications devices.

### BACKGROUND

Some wireless communications devices are able to download image media, such as digital pictures and digital video clips, from the Web, for example. Wireless communications devices having onboard digital cameras can furthermore take digital pictures or even digital video clips.

However, organizing and presenting image media on a wireless communications device is challenging, particularly in view of the small (usually LCD) display screen of these devices. Traditionally, the image media is presented either in list format (i.e. a list of image files, folders, subfolders, etc., usually with a small icon beside each file name) or as a set of scaled-down, thumbnail images, usually with file names adjacent each thumbnail. Neither of these two options is particularly ergonomic since the user must either sacrifice hierarchical knowledge (location within the folder structure) or sacrifice the visual representation of the image (the thumbnail) and rely only on the folder name and file name. Neither of these traditional methods of displaying image media enables the user to efficiently navigate through his or her image media. In other words, organizing one's image media (or finding specific images or videos) has been traditionally challenging, especially when the user interface (UI) is constrained by the small size of the wireless communications device, i.e. where opening multiple windows (one of a list, one for the thumbnails) is either unfeasible or would simply not be helpful. Furthermore, on a non-touch screen device, navigation using a plurality of input means (e.g., trackball, thumbwheel, jogdial, buttons, keys, etc.) is difficult because one has to traverse a list of folders or files.

Therefore, an improved method of displaying image media on a wireless communications devices that overcomes these shortcomings would be highly desirable.

### BRIEF DESCRIPTION OF THE DRAWINGS

Further features and advantages of the present technology will become apparent from the following detailed description, taken in combination with the appended drawings, in which;

FIG. 1 is a flowchart outlining steps of a method of displaying image media on a display screen of a wireless communications device in accordance with the present technology;

FIG. 2 is a flowchart outlining further steps of the method of displaying image media in accordance with a variant of the present technology;

FIG. 3 is a block diagram of key components of a wireless communications device on which the present technology can be implemented;

FIG. 4 is a screenshot taken from a display screen of a wireless communications device that concurrently presents, as a hybrid view, both a list of folders and thumbnail images; and

FIG. 5 is a screenshot taken from a display screen of a wireless communications device that concurrently presents, as a different hybrid view, the list of folders and thumbnail images as well as the file name and file size for one particular image that has been selected by the user.

It will be noted that throughout the appended drawings, like features are identified by like reference numerals.

### DETAILED DESCRIPTION

The present technology provides, in general, a method for displaying image media on a wireless communications device that entails displaying a hybrid view of the image media by concurrently presenting a list of folders containing image media and thumbnail images of the image media. The thumbnail images can be scaled-down images of digital pictures or scaled-down frames of digital video. By simultaneously presenting both the list of folders and the thumbnail images, a user of the wireless communications device can more easily navigate through the image media, find specific images or video clips, or organize (or re-organize) the image media.

Accordingly, an aspect of the present technology is a method of displaying image media on a display of a wireless communications device, the method including a step of displaying a hybrid view of the image media by presenting a list of folders containing image media and by concurrently presenting thumbnail images of the image media corresponding to at least one of the folders.

Another aspect of the present technology is a computer program product that includes code adapted to perform the steps of the foregoing method when the computer program product is loaded into memory and executed on a processor of a wireless communications device.

Yet another aspect of the present technology is a wireless communications device having an input device for enabling a user to select image media, a processor and memory for generating a hybrid view of the image media having both a list of folders containing the image media and thumbnail images of the image media, and a display for displaying the hybrid view of the image media by presenting the list of the folders containing the image media and by concurrently presenting thumbnail images of the image media corresponding to at least one of the folders.

The details and particulars of these aspects of the technology will now be described below, by way of example, with reference to the attached drawings.

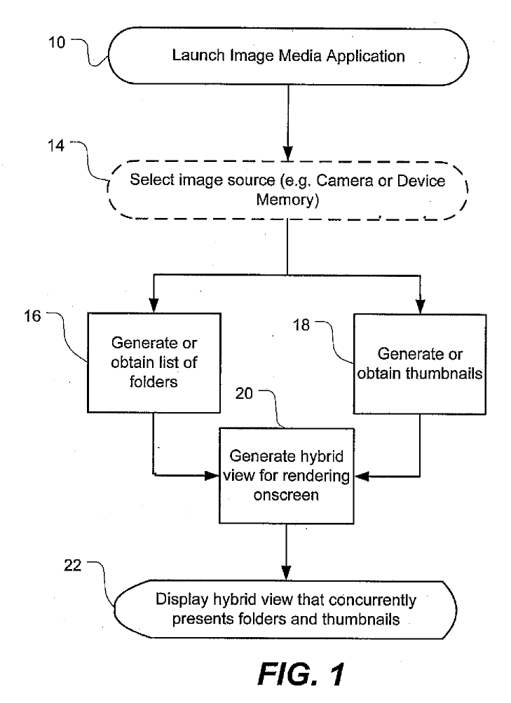

FIG. 1 is a flowchart outlining steps of a method of displaying image media (e.g. digital photographs or digital video) in accordance with one implementation of the present technology. As shown in FIG. 1, after an initial step of launching an image media application on the wireless communications device (step 10), the image media application determines a default general folder (e.g. “My Pictures”) based on the presence of the media card and the contents it contains At optional step 14, the image media application can further enable the user of the wireless device to select or specify an image media source (e.g. camera or device memory). It bears repeating that step 14 is optional, and as such, FIG. 1 shows this optional step in dashed lines. In other words, in other implementations of this technology, the user may not need to specify the source of the image media (i.e. it may be preset based on user preferences, settings, etc. or based on patterns of use.)

In the particular implementation depicted in FIG. 1, once the image media application is running and the user has (optionally) specified the general folder or image media source, then a subsequent step (step 16) entails generating or obtaining a list of folders containing image media (e.g. digital pictures or digital video). Generating a list of folders (step 16) can be accomplished by simply compiling a list of all folder names under the general folder (or under a specific directory or drive or at a specific location on the device). Otherwise, a pre-generated list can be simply obtained from a cache or other memory location on the device.

As shown at step 18, the image media application (or other application running on the wireless device) also generates or obtains “thumbnails” or thumbnail images (i.e. scaled-down images) of the image media. Step 18 can be done prior to, concurrent with, or subsequent to step 16. Once the thumbnails and folder list have been created (steps 16 and 18), a “hybrid view” of both the folders and thumbnails is generated (at step 20) by the device for rendering onscreen. At step 22, the device then displays (i.e. renders) the hybrid view on the display screen of the device by concurrently presenting both the folders and the thumbnails. In other words, this hybrid or compound view simultaneously presents the folders containing the image media as well as the thumbnails created from the image media contained in at least one of the folders. By simultaneously displaying the folders and the thumbnails in this hybrid view, the user is better able to navigate through the image media (e.g. photos and video), find specific images or video clips, save images or videos to specific folders, organize or reorganize the images or videos, etc. This hybrid view therefore facilitates the management and accessibility of image media on wireless communications devices where small display screens (or the operating systems) generally preclude a user from opening multiple windows to simultaneously view folder lists and thumbnails for more efficient handling of the image media.

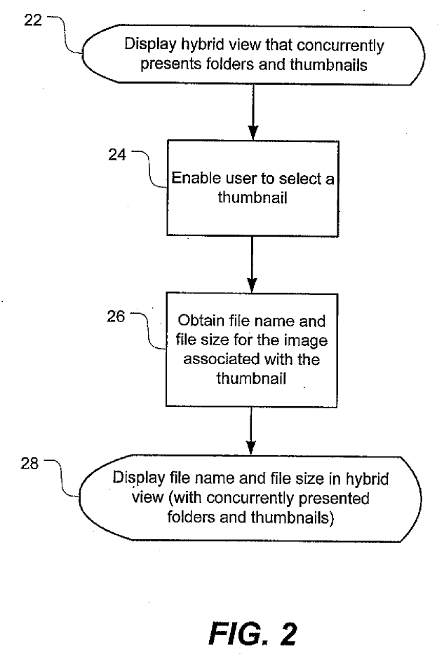

FIG. 2 is a flowchart outlining further steps of the method of displaying image media in accordance with a variant of the present technology. FIG. 2 depicts a variant of the method shown in FIG. 1 wherein the user can further select (e.g. highlight or click) one of the thumbnail images in order to cause the display to further present a file name and file size, preferably as a footer, i.e. beneath the thumbnail images. Of course, it will be appreciated that the file name and file size could be presented elsewhere on the display (i.e. not necessarily as a footer). Also, in this variant, it is not necessary that the footer present both the file name and file size, e.g. the file name alone could be presented.

In the particular implementation depicted in FIG. 2, after the step (step 22) of displaying the hybrid view (that concurrently presents a list of folders and thumbnails), the application optionally further enables the user to select or specify one of the thumbnails (step 24), for example, by highlighting or clicking the thumbnail. This causes the application to obtain or otherwise determine the file name and optionally also the file size of the image corresponding to the thumbnail selected by the user (step 26). Finally, at step 28, the file name and file size are displayed as part of this modified hybrid view in which the list of folders and the thumbnails are simultaneously displayed on the display screen of the wireless device.

This novel method is preferably implemented on a wireless communications device such as the BlackBerry® by Research in Motion Limited (or on other wireless handhelds, cellular phones, wireless-enabled laptops, wireless-enabled PDAs, or other such mobile devices).

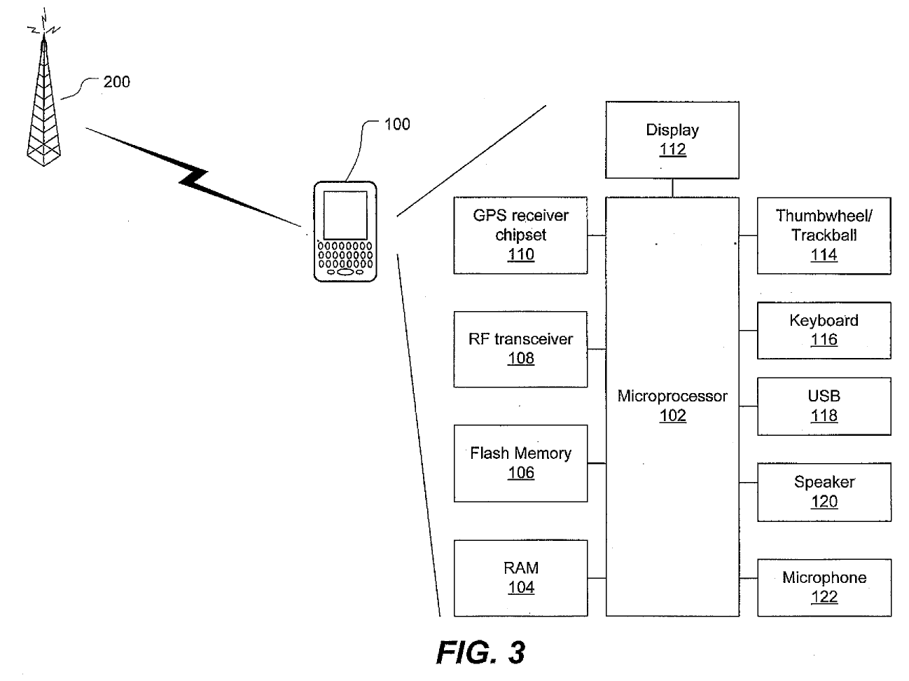

FIG. 3 is a block diagram depicting certain key components of a wireless communications device 100. It should be expressly understood that this figure is intentionally simplified to show only certain components; the device 100 of course includes other components beyond what are shown in FIG. 2. The device 100 includes a microprocessor 102 (or simply a “processor”) which interacts with memory in the form of RAM 104 and Flash Memory 106. The device 100 includes an RF transceiver 108 for communicating wirelessly with one or more base stations 200. The device 100 may optionally include a GPS receiver chipset 110 for receiving GPS radio signals transmitted from one or more orbiting GPS satellites. In terms of input/output devices or user interfaces, the device 100 typically includes a display 112 (e.g. a small LCD display screen), a thumbwheel and/or trackball 114, a keyboard 116, a USB 118 or serial port for connecting peripheral equipment, a speaker 120 and a microphone 122. The processor and memory thus enable the image media application to run on the wireless device. Thumbwheel/trackball 114 may be a depressible thumbwheel/trackball that is used for navigation, selection of menu choices and confirmation of action. For example, when using thumbwheel/trackball 114 to scroll over a photo, depressing the trackball will select the photo, triggering an enlarged display of the photo, Keyboard 116 contains alphanumeric keys to represent a QWERTY arranged keyboard, as well as a numeric phonepad (i.e., keys 0-9). Further, keyboard 116 may also contain symbol, function and command keys. Examples of these keys may include a phone send/end key, a menu key (i.e., bring up different menu items) and an escape key.

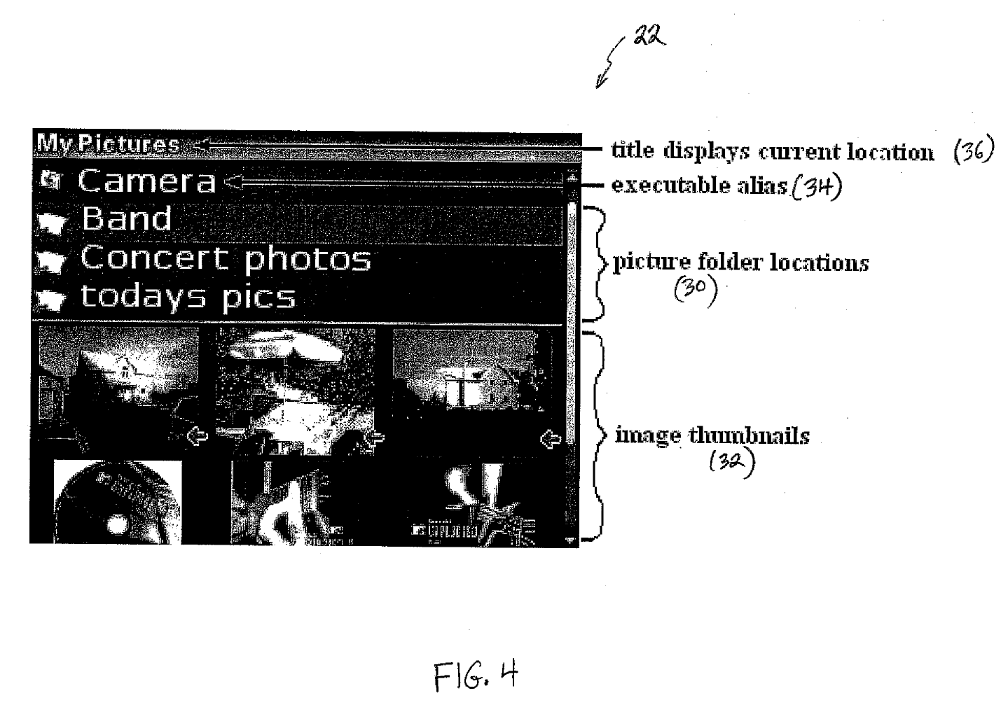

FIG. 4 is a screenshot taken from a display screen of a wireless communications device that concurrently presents, as a hybrid view 22, both a list of folders 30 and thumbnail images 32. This screenshot is presented merely by way of example to illustrate one particular implementation of this technology. Other configurations or arrangements of folders and thumbnails can of course be utilized. For example, the thumbnails could be grouped to one side rather than beneath the list of folders. As another example, the thumbnails could be grouped directly beneath the selected folder, which might be useful where the list of folders is so long that it occupies the visible portion of the display screen, thus requiring the user to scroll down to see the thumbnails (using the scroll bar, for example). As optional features, the hybrid view 22 can further present one or more sources 34 of the image media, e.g. “Camera” or “Device Memory”. This “data source” is also referred to as an “executable alias”, as shown in FIG. 4. As further shown in FIG. 4, the folders 30 can be grouped hierarchically under each of the one or more sources 34. As yet a further option, the hybrid view can additionally present the general folder 36 or directory (e.g. “My Pictures” in a header), as depicted in FIG. 4.

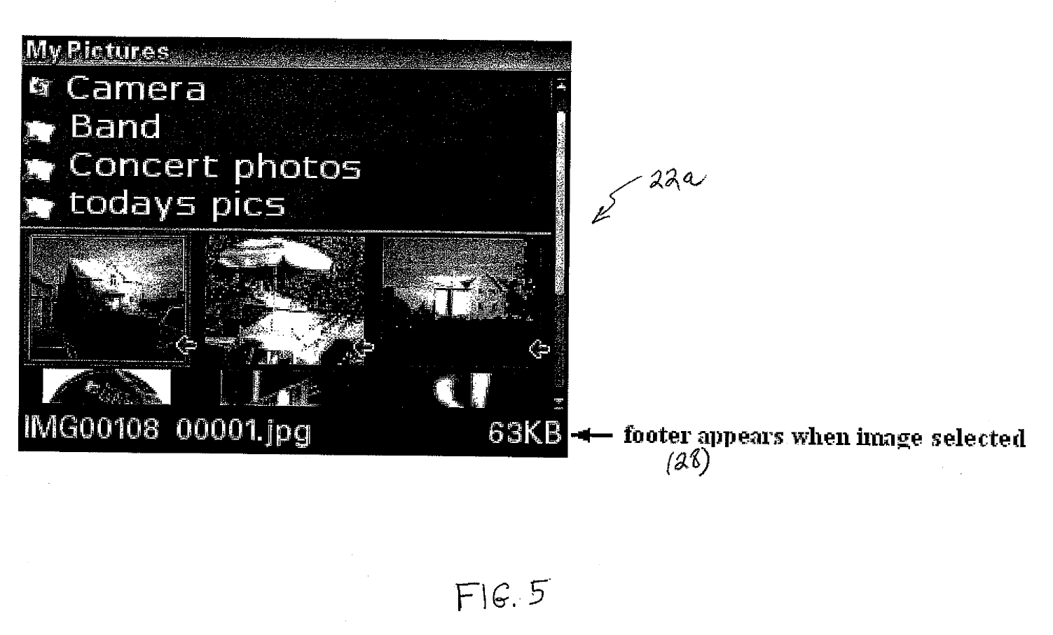

FIG. 5 is a screenshot taken from a display screen of a wireless communications device that concurrently presents, as a different hybrid view 22a, the list of folders and thumbnail images as well as a footer 28 presenting the file name and file size for one particular image that has been selected by the user. This screenshot is also presented merely by way of example to illustrate one particular implementation of this technology. Other configurations or arrangements can be used. For example, the file name and file size can be relocated as a header instead of as a footer, or alternatively, the file name and file size could be made to appear in parentheses beside the folder under which it is filed. Other items that may be added to footer 28 may include photo image tag, classification keywords, date and time.

In a variant of this hybrid view, the highlighted folder and image may be of different colours or shades, based on where the focus is. For example, if the user is in the “Band” folder and the user's cursor is on the picture of the umbrella (the top middle photo in FIGS. 4 and 5), the picture of the umbrella would appear brighter (or highlighted or otherwise made more noticeable) since the focus is on this photo. Alternatively, the “Band” folder could also be highlighted but have a different colour/shade than the photo. As another alternative, the “Band” folder could be less bright (i.e. have a lesser pixel intensity) than the photo (because the focus is on the photo). As will be appreciated, these examples of various techniques for highlighting images and folders can be varied to achieve different visual effects for aiding the user in navigating through the images and folders.

The foregoing method steps can be implemented as coded instructions in a computer program product. In other words, the computer program product is a computer-readable medium upon which software code is recorded to perform the foregoing steps when the computer program product is loaded into memory and executed on the microprocessor of the wireless communications device.

This new technology has been described in terms of specific implementations and configurations which are intended to be exemplary only. The scope of the exclusive right sought by the Applicant is therefore intended to be limited solely by the appended claims.

1. A method of displaying image media on a display of a wireless communications device, the method comprising a step of displaying a hybrid view of the image media by presenting a list of folders containing image media and by concurrently presenting thumbnail images of the image media corresponding to at least one of the folders.

2. The method as claimed in claim 1 wherein the step of displaying the hybrid view of the image media comprises displaying folders and thumbnail images of digital pictures contained within one of the folders selected by the user.

3. The method as claimed in claim 1 wherein the step of displaying the hybrid view of the image media comprises displaying folders and thumbnail images of frames of digital video contained within one of the folders selected by the user.

4. The method as claimed in claim 1 further comprising a step of enabling the user to select one of the thumbnail images to further display a file name and file size.

5. The method as claimed in claim 1 further comprising steps of displaying one or more sources of the image media and grouping hierarchically the folders containing the image media under each of the one or more sources.

6. A computer program product comprising code adapted to perform the steps of claim 1 when the computer program product is loaded into memory and executed on a processor of a wireless communications device.

7. The computer program product comprising code adapted to perform the steps of claim 2 when the computer program product is loaded into memory and executed on a processor of a wireless communications device.

8. The computer program product comprising code adapted to perform the steps of claim 3 when the computer program product is loaded into memory and executed on a processor of a wireless communications device.

9. The computer program product comprising code adapted to perform the steps of claim 4 when the computer program product is loaded into memory and executed on a processor of a wireless communications device.

10. The computer program product comprising code adapted to perform the steps of claim 5 when the computer program product is loaded into memory and executed on a processor of a wireless communications device.

11. A wireless communications device comprising:
an input device for enabling a user to select image media;
a processor and memory for generating a hybrid view of the image media having both a list of folders containing the image media and thumbnail images of the image media; and
a display for displaying the hybrid view of the image media by presenting the list of the folders containing the image media and by concurrently presenting thumbnail images of the image media corresponding to at least one of the folders.

12. The wireless communications device as claimed in claim 11 wherein the hybrid view of the image media comprises thumbnail images of digital pictures contained within one of the folders selected by the user.

13. The wireless communications device as claimed in claim 11 wherein the hybrid view of the image media comprises thumbnail images of frames of digital video contained within one of the folders selected by the user.

14. The wireless communications device as claimed in claim 11 wherein the display presents one or more sources of the image media and wherein the folders are grouped hierarchically under each of the one or more sources.

15. The wireless communications device as claimed in claim 11 wherein the display further presents a file name and file size of an image that is selected by the user.

16. The wireless communications device as claimed in claim 11 further comprising a non-touch input means for use in navigating the hybrid view.

17. The wireless communications device as claimed in claim 16 wherein said non-touch input means is a trackball/thumbwheel.

18. The wireless communications device as claimed in claim 17 wherein said non-touch input means is user-selectable and depressible whereby the user can select an image by depressing the non-touch input means.

19. The wireless communications device as claimed in claim 11 wherein the hybrid view comprises a footer that presents a file name and file size of an image last selected by the user.
